(19) United States
(12) Patent Application Publication
(10) Pub. No.: US 2003/0093456 A1
(43) Pub. Date: May 15, 2003

(54) Low overhead exception checking

(76) Inventors: Otto Lodewijk Steinbusch, Cupertino, CA (US); Menno Menasshe Lindwer, Eindhoven (NL)

Correspondence Address: U.S. Philips Corporation, 580 White Plains Road, Tarrytown, NY, 10591, US

(21) Appl. No.: 10/277,538

(22) Filed: Oct. 22, 2002

(30) Foreign Application Priority Data
Oct. 25, 2001 (EP) 01402778.3

(51) Int. Cl. G06F 17/00

(52) U.S. Cl. 709/1

(57) ABSTRACT

Exception detection is expedited in virtual machine interpreter (VMI) accelerator hardware (120) by dispatching fetched bytecodes along with instructions that cause a processor interrupt if the fetched bytecodes cause an exception to be thrown. The processor interrupt serves to indicate to the VMI (120) that an exception condition exists, thereby obviating the need to for the VMI (120) to wait for the result of an exception check to be sent from the CPU (110) to the VMI (120).

### FIELD OF THE INVENTION

The present invention relates generally to computer programming languages, and more particularly to the translation and execution of a virtual machine language.

### BACKGROUND OF THE INVENTION

Computer programming languages are used to create applications consisting of human-readable source code that represents instructions for a computer to perform. Before a computer can follow the instructions however, the source code must be translated into computer-readable binary machine code.

A programming language such as C, C++, or COBOL typically uses a compiler to generate assembly language from the source code, and then to translate the assembly language into machine language which is converted to machine code. Thus, the final translation of the source code occurs before runtime. Different computers require different machine languages, so a program written in C++for example, can only run on the specific hardware platform for which the program was written.

Interpreted programming languages are designed to create applications with source code that will run on multiple hardware platforms. Java™ is an interpreted programming language that accomplishes platform independence by generating source code that is converted before runtime to an intermediate language known as “bytecode” or “virtual machine language.” At runtime, a virtual machine translates bytecodes into platform-appropriate machine code. In essence, the virtual machine is not a physical structure, but rather is a self-contained operating environment (generated by interpreter software or a sequence of processor instructions) that interprets bytecodes for the hardware platform by selecting the corresponding native machine language instructions that are stored within the VM or in the CPU. The native instructions are then supplied to and consecutively executed in the CPU of the hardware platform. A typical virtual machine requires 20-60 cycles of processing time per bytecode (depending on the quality and complexity of the bytecode) to perform an FDD series of operations. To interpret each bytecode, a Java virtual machine performs a “fetch, decode, and dispatch” (FDD) series of operations. For each bytecode instruction the Java Virtual Machine (JVM) contains a corresponding execution program expressed in native central processing unit (CPU) instructions. The JVM causes the CPU to fetch or read a virtual machine instruction from memory, to decode the CPU address of the execution program for the bytecode instruction, and to dispatch by transferring control of the CPU to that execution program. The interpretation process can be time-consuming.

Adding a preprocessor (a virtual machine interpreter (VMI)) between a memory and a CPU accelerates the processing of virtual machine instructions, as disclosed in PCT Patent Application No. WO9918484, which has the same inventor and assignee as the present invention. The VMI is a hardware module that interprets Java bytecodes by generating native CPU instructions “on-the-fly.” First, a VMI reads (fetches) a bytecode from memory. Next, the VMI looks up a number of properties of (decodes) the fetched bytecode. The properties accessed by the VMI determine how the bytecode will be processed into native instructions for dispatch to and execution in the CPU. Thus, the VMI can perform each FDD in hardware rather than in software. While the CPU is executing one instruction, the VMI fetches and processes the next bytecode into CPU instructions.

While interpreting a sequence of bytecodes, a virtual machine may encounter a bytecode (or sequences of bytecodes) that causes an illegal operation, such as an instruction to access outside the bounds of an array. The performance of such an illegal operation causes an exception to be thrown which must be handled and cleared before subsequent functions can be called, unless the subsequent functions are exception-related such as ExceptionOccurred, ExceptionDescribe, and ExceptionClear. In processor-based exception checking procedures, an exception is pending until an exception check determines whether the operation called for by a bytecode will actually result in the performance of the illegal operation, because calling non-exception-related functions while an exception is pending may lead to unexpected results. However in Java, exceptions are not held in a pending state while the exception check is performed. Rather, exception conditions are explicitly checked through the execution of CPU instructions. Once an exceptional situation has been detected, an exception object is created according to the exception type, and exception-handling software is invoked.

The virtual machine approach to exception checking is not optimal with respect to VMI implementations. For example, to interpret the IALoad bytecode, a virtual machine generates instructions that compare the index of an array access to the size of the array, an operation which can result in an out-of-bounds condition. The VMI reacts as if the potential out-of-bounds condition is a type of conditional branch, and thus suspends processing of bytecodes for a substantial amount of time while waiting for receipt of an exception check result from the CPU that indicates whether the out-of-bounds exception actually occurs. Therefore, this exception handling solution requires a substantial amount of overhead (i.e., a burden on processing time).

There is a need for a method of processing virtual machine instructions with a virtual machine hardware accelerator (such as the Virtual Machine Interpreter) which reduces the processing time required to perform exception detection and checking.

### SUMMARY OF THE INVENTION

The present invention fulfills the needs described above by providing a system and method of detecting exceptions while processing virtual machine instructions that advantageously minimizes the processing delays incident to exception checking by obviating the need to wait for the return of an exception check result from the processor.

More specifically, according to the system and method of the present invention a virtual machine hardware accelerator (such as the VMI) determines whether a bytecode will throw an exception by processing and dispatching native instructions that cause the CPU to generate an interrupt if the bytecode will result in an illegal operation.

Briefly, an exemplary embodiment of the method of processing virtual machine instructions includes fetching a bytecode and incrementing a bytecode counter. The VMI processes the fetched bytecode into native instructions (i.e., the VMI “generates” a sequence of native instructions) executable by a processor (CPU) and the VMI dispatches the native instructions corresponding to the bytecode along with native instructions that will cause a processor interrupt if execution of native instructions called for by the bytecode results in an illegal operation (the “interrupt instructions”). The instruction set of most CPUs includes special interrupt functions, some of which are unconditional interrupt instructions such as TRAP, SYSCALL, or BREAK (for MIPs processors). However, when invoked unconditional interrupt instructions cause a CPU interrupt regardless of whether an exception exists. Thus, unconditional interrupt instructions are not used by the VMI to detect exceptions, because doing so would require the VMI to wait for receipt of the exception condition from the CPU before invoking an unconditional interrupt instruction. Rather, the VMI detects exceptions using conditional interrupt instructions.

The conditional interrupt situation is created when the VMI generates instruction sequences that can cause an interrupt when the exception condition exists. The VMI generates a sequence of native instructions that cause a processor interrupt for example by creating an algorithm that performs computations on the exception indicator that result in a processor interrupt. Alternatively, the VMI generates individual conditional interrupt instructions from the CPU instruction set. Either type of interrupt instruction or instruction sequence is “generated” by the VMI as part of the sequence of native instructions dispatched to the CPU.

The CPU executes the native instructions called for by the bytecode along with the interrupt instructions. If execution of the native instructions called for by the bytecode results in an illegal operation, the interrupt instructions cause a processor interrupt. Accordingly, there is no need to transfer an exception check result from the CPU to the VMI. Consequently, Java exception checking according the present invention is less time-consuming.

When a processor interrupt occurs, the exemplary system can be programmed to handle the exception. In principle, for every operation that could result in an exception, the Java programmer must indicate an appropriate response (i.e. provide code to handle that exception). At the bytecode level therefore, every sequence of bytecodes that constitutes a method must contain extra sequences of bytecodes and a table that indicates a sequence of exception-handling bytecodes to be executed for every conceivable exceptional situation.

The system of an exemplary embodiment of the present invention is an apparatus for processing bytecodes that includes a processor with a native instruction set that executes native instructions, and an instruction memory that stores bytecodes. A VMI fetches bytecodes from the instruction memory, processes the bytecodes into native CPU instructions and dispatches the bytecodes along with interrupt instructions that cause a processor interrupt if execution of the processed virtual machine instructions results in an illegal operation. A virtual machine instruction counter is incremented after each bytecode is processed. Alternatively, the VMI either retrieves the interrupt instructions from a CPU instruction set or generates the interrupt instructions.

The present invention can be implemented in systems that execute Java™ bytecode using virtual machines, such as JVMs made by Sun Microsystems. However, the invention can also be implemented using other Java™ virtual machines such as the Microsoft Virtual Machine, and is also applicable to systems that execute other interpreted languages such as Visual Basic, dBASE, BASIC, and .NET.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE DRAWINGS

The accompanying drawings, which are incorporated in and form part of the specification, illustrate the present invention when viewed with reference to the description, wherein:

FIG. 1 is a block diagram that shows the functional elements of an exemplary embodiment of the environment of the present invention.

FIG. 2 is a flowchart that shows a method according to an exemplary embodiment of the present invention.

### DESCRIPTION OF PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

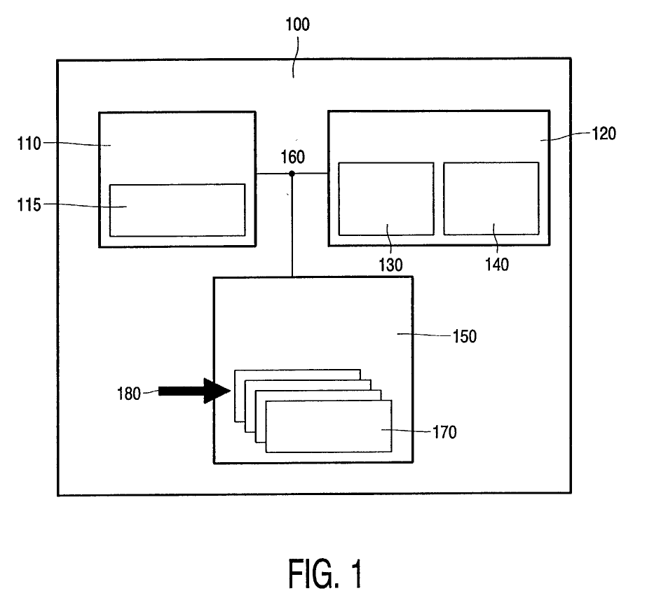

Referring now in detail to an exemplary embodiment of the present invention, which is illustrated in the accompanying drawings in which like numerals designate like components, FIG. 1 is a block diagram of the exemplary embodiment of the environment of the present invention. The basic components of the environment are a hardware platform 100 that includes a processor 110, a preprocessor 120, and an instruction memory 150, which are all connected by a system bus 160. The preprocessor 120 includes a control register 130 and a translator 140. A hardware platform 100 typically includes a central processing unit (CPU), basic peripherals, and an operating system (OS). The processor 110 of the present invention is a CPU such as MIPS, ARM, Intel×86, PowerPC, or SPARC type microprocessors, and contains and is configured to execute hardware-specific instructions, hereinafter referred to as native instructions. In the exemplary embodiment of the present invention, the translator 140 is a Java™ virtual machine (JVM), such as the KVM by Sun Microsystems. The instruction memory 150 contains virtual machine instructions, for example, Java™ bytecode 170. The preprocessor 120 in the exemplary embodiment is the Virtual Machine Interpreter (VMI) disclosed in WO9918486, and is configured to fetch a virtual machine instruction (for example, a bytecode 170) from the instruction memory 150 and to translate the virtual machine instruction into a sequence of native CPU instructions. The VMI 120 is a peripheral on the bus 160 and may act as a memory-mapped peripheral, where a predetermined range of CPU addresses is allocated to the VMI 120. The VMI 120 manages an independent virtual machine instruction pointer 180 (the “bytecode counter”) indicating the current (or next) virtual machine instruction in the instruction memory 150.

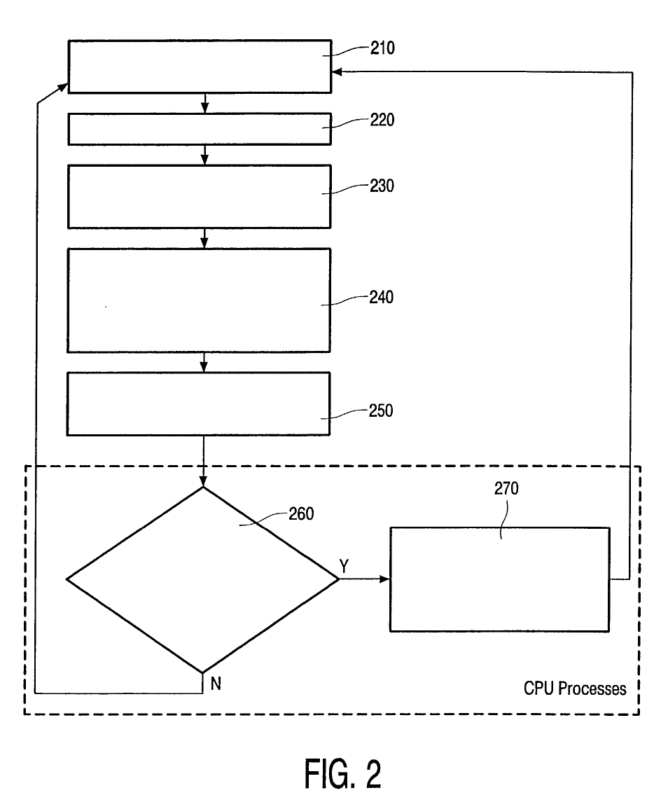

FIG. 2 is a flowchart that shows a method according to an exemplary embodiment of the present invention. Referring in detail to FIG. 2, in step 210 the VMI 120 increments the bytecode counter BCC 180 before proceeding in step 220 to fetch each bytecode 170 from the instruction memory 150. In step 230, the VMI 120 decodes each bytecode 170 by accessing the properties for the bytecode 170. In step 240, the VMI 120 retrieves a sequence of native instructions from the translation table 140 that includes the translation of the fetched bytecode 170, the interrupt instructions that detect exception conditions when executed along with a fetched bytecode 170, as well as other instructions that must be executed along with the fetched bytecode 170. The interrupt instructions detect exception conditions by invoking a processor interrupt when the execution of instructions called for by the fetched bytecode 170 causes an illegal operation. These interrupt instructions are existing CPU commands (specified in the CPU instruction set 115) generated by the VMI 120 or instruction sequences (algorithms) generated by the VMI 120.

Interrupt instruction sequences can include any combination of native instructions that will induce a processor interrupt. According to an exemplary embodiment, the VMI generates computational instructions that operate on the exception indicator so as to cause an arithmetic overflow only if the exception will actually occur. For example, the bytecode processed by the VMI 120 can call for an array index check, wherein the corresponding native instructions will compare the index to the array bounds (such as by using SLTU). The outcome of this comparison (0=OK, 1=FAIL) is stored in a CPU register and becomes the exception indicator. This VMI-generated interrupt instruction sequence creates an interrupt if the comparison fails, by shifting the exception indicator 31 positions to the left and adding the exception indicator to itself as follows:

SLTU $1, $bound, $idx

SLL $1, $1, 31

ADD $1, $1, $1 If the value of the shifted exception indicator is 1, the largest possible negative number (on a 31-bit machine) is obtained. The result of adding this number to itself is a number that causes an arithmetic overflow exception. Another possible initiator of CPU interrupt conditions is a divide-by-zero function.

The VMI 120 (in step 250) dispatches (to the CPU 110) the sequence of native instructions that corresponds to the fetched bytecode 170 along with the interrupt instructions. Steps 260 and 270 occur within the CPU. The CPU 110 executes the sequence of native instructions and the interrupt instructions. If an exception is thrown in step 260, a processor interrupt is caused by the interrupt instructions, and an exception-handling process is invoked in step 270. For example, the VMI 120 can be programmed to dispatch exception-handling bytecode sequences along with each fetched bytecode sequence that constitutes a method. If no exception is thrown, the VMI 120 proceeds to process the next bytecode 170 from the instruction memory 150 by returning to step 210.

Although the present invention is described with respect to implementation in virtual machine interpreter accelerator hardware, implementation in conjunction with various other bytecode processing systems is possible as will be understood by those skilled in the art.

In view of the foregoing, it will be appreciated that the present invention provides a system and a method for accurate and efficient detection of exceptions during processing of virtual machine instructions. Still, it should be understood that the foregoing relates only to the exemplary embodiments of the present invention, and that numerous changes may be made thereto without departing from the spirit and scope of the invention as defined by the following claims.

1. A method of processing virtual machine instructions, comprising:
fetching a virtual machine instruction;
processing the virtual machine instruction into native instructions executable by a processor;
dispatching the processed native instructions to the processor for execution along with native instructions that cause a processor interrupt if execution of the processed native instructions results in an illegal operation;
executing the processed native instructions and the native instructions that cause a processor interrupt if execution of the processed native instructions results in an illegal operation.

2. The method of claim 1, wherein fetching and processing the virtual machine instruction into native instructions executable by a processor is accomplished by a Virtual Machine Interpreter (VMI) virtual machine hardware accelerator.

3. The method of claim 1, further comprising generating native instructions that cause a processor interrupt if execution of the processed native instructions results in an illegal operation.

4. The method of claim 3, wherein executing the processed native instructions and the native instructions that cause a processor interrupt if execution of the processed native instructions results in an illegal operation further comprises:
generating an exception check result if execution of the dispatched native instructions results in an illegal operation; and
executing the native instructions that cause a processor interrupt if execution of the processed native instructions results in an illegal operation by performing an algorithm on the exception check result where a processor interrupt is caused.

5. An apparatus (100) for processing virtual machine instructions, comprising:
a processor (110) having a native instruction set and configured to execute native instructions;
an instruction memory (150), configured to store virtual machine instructions; and
a preprocessor (120), configured to fetch virtual machine instructions from the instruction memory, to process the fetched virtual machine instructions into native instructions executable by the processor, to append native instructions that cause a processor interrupt if execution of the processed virtual machine instructions result in an illegal operation, and to dispatch the processed native instructions and the appended native instruction to the processor for execution.

6. The apparatus (100) of claim 5, wherein the preprocessor (120) is a Virtual Machine Interpreter (VMI) virtual machine hardware accelerator.

7. The apparatus (100) of claim 5, wherein the preprocessor (120) is further configured to generate the native instructions that cause a processor interrupt if execution of the processed native instructions results in an illegal operation.

8. The apparatus (100) of claim 7, wherein the processor (110) is further configured to execute the processed native instructions and the appended native instructions, to generate an exception indicator if execution of the dispatched native instructions results in an illegal operation, and to execute the appended native instructions by performing an algorithm on the exception indicator that causes a processor interrupt.
